(19) United States
(12) Patent Application Publication
(10) Pub. No.: US 2012/0093570 A1
(43) Pub. Date: Apr. 19, 2012

(54) FOLDER WITH ENHANCED PAPER BINDING FIXTURES

(76) Inventor: Yoav Ben-Or, Dollard des Omeaux (CA)

(21) Appl. No.: 13/086,142

(22) Filed: Apr. 13, 2011

Related U.S. Application Data
(60) Provisional application No. 61/324,877, filed on Apr. 16, 2010.

(51) Int. Cl. B42F 13/14; B42F 13/02

(52) U.S. Cl. 402/21; 402/68

(57) ABSTRACT

A folder having at least one paper binding fixture affixed to it. Further, the paper binding fixture can be capable of being opened and closed such that when opened sheets of paper can be placed on a male protrusion and when closed the sheets of paper can be bound by releasably coupling the male protrusions to a female opening. Further, the paper binding fixture can have enhanced safety benefits that substantially reduce the risk of injury to a user. Also, the paper binding fixture can reduce the risk of tearing sheets of paper bound by it.

### CROSS-REFERENCE TO RELATED APPLICATIONS

This application claims priority to U.S. Provisional Patent Application No. 61/324,877, filed Apr. 16, 2010 the content of which is incorporated herein by reference in its entirety.

### FIELD

The present invention generally relates to folders with paper binding fixtures.

### SUMMARY OF THE INVENTION

In exemplary embodiments, a folder having binding fixture(s) can comprise: a folder; a binding fixture(s) that can be coupled to the folder, wherein the binding fixture(s) can comprise a male protrusion(s) and/or a female opening(s). Further, in exemplary embodiments, the male protrusion(s) can be constructed such that paper with holes in it can be capable of being placed on the male protrusion(s); and/or wherein the male protrusion(s) can be received by and/or releasably coupled to the female opening(s) such that paper can be releasably retained by the binding fixture(s) coupled to the folder.

In exemplary embodiments, the binding fixture(s) can be designed to substantially reduce the risk of injuring a user and/or damaging the retained paper.

In exemplary embodiments, the folder can further comprise hinge(s) that can enable the folder to bend and/or have a three-dimensional shape.

In exemplary embodiments, the folder can further comprise a plurality of hinges that can segment the folder into a first region, a second region, and/or a third region. Further, the first region and/or second region can be substantially planer in shape and/or the third region can be located between the first and/or second region and/or can extend at an angle to the first region and/or the second region.

In exemplary embodiments, the third region can further comprise a plurality of surfaces forming a “W” shape with the first and second region.

In exemplary embodiments, the binding fixture(s) can be releasably coupled to the folder, permanently affixed to the folder, and/or semi-permanently affixed to the folder.

In exemplary embodiments, the binding fixture(s) can be semi-permanently affixed to the folder and/or permanently affixed to the folder to, for example, reduce the risk injury due to swallowing the binding fixture(s).

In exemplary embodiments, the male protrusion(s) can be releasably coupled to the female opening(s) by (i) a frictional interaction of the male protrusion and/or female opening, (ii) plastic deformation of the male protrusion and/or female opening, and/or (iii) elastic deformation of the male protrusion and/or female opening.

In exemplary embodiments, the binding fixture(s) can further comprise a male protrusion(s) region wherein the male protrusion(s) can be located; a female receiving region(s) wherein the female opening(s) can be located; and/or a bending region located between the male protrusion(s) region and/or female receiving region(s), wherein the bending region can deform when the male protrusion(s) is received by and/or releasably coupled to the female opening(s).

In exemplary embodiments, (i) the male protrusion and/or female opening can be designed to fail such that the binding fixture no longer retains paper; (ii) the bending region can be designed to fail such that the binding fixture no longer retains paper; and/or the failure such that the binding fixture no longer retains paper can be designed to, for example, reduce the risk injury due to swallowing pieces of the binding fixture(s).

In exemplary embodiments, the male protrusion can be constructed such that it does not include sharp surfaces and/or edges; and/or the male protrusion does not include sharp surfaces and/or edges to (i) reduce the risk of injury to a user and/or (ii) reduce the stress concentration on paper retained by the binding fixture.

In exemplary embodiments, the male protrusion can further comprise geometric variations on its surface and/or female opening can further comprise geometric variations on its surface. In exemplary embodiments, the geometric variations can interact such that male protrusion and/or female opening releasably couple. In exemplary embodiments, the geometric variations can interact such that the male protrusion and/or female opening can releasably couple at various offsets.

In exemplary embodiments, the folder, the binding fixture(s), and/or any elements thereof can be fabricated from a recyclable material and/or recycled material to provide the benefit of reducing waste. In exemplary embodiments, the material can be a plastics, polyethylene, ultra high molecular weight polyethylene (UHMWPE), ultra low molecular weight polyethylene (ULMWPE or PE-WAX), high molecular weight polyethylene (HMWPE), high density polyethylene (HDPE), high density cross-linked polyethylene (HDXLPE), cross-linked polyethylene (PEX or XLPE), medium density polyethylene (MDPE), linear low density polyethylene (LLDPE), low density polyethylene (LDPE), and/or very low density polyethylene (VLDPE).

### BRIEF DESCRIPTION OF THE DRAWINGS

The features and advantages of the disclosure will be more fully understood with reference to the following description of the invention when taken in conjunction with the accompanying figures, wherein:

FIGS. 1A-1B illustrate a folder with exemplary paper binding fixtures;

FIG. 2 illustrates an exemplary paper binding fixture in an opened and closed configuration;

FIG. 3 illustrates an exemplary paper binding fixture with the capability to remain in an opened and closed configuration at various heights;

FIG. 4 illustrates an exemplary paper binding fixture capable of acting as a hole puncher;

FIG. 5 illustrates an exemplary paper binding fixture having a modified male protrusion; and

FIGS. 6A-6C illustrate sheets of paper placed in exemplary paper binding fixtures.

### DETAILED DESCRIPTION

The present invention generally relates to a folder having at least one binding fixtures affixed to it. The binding fixtures can be designed to retain a plurality of sheets of paper and can lessen the risk of, for example, injuring a user and/or damaging the bound paper.

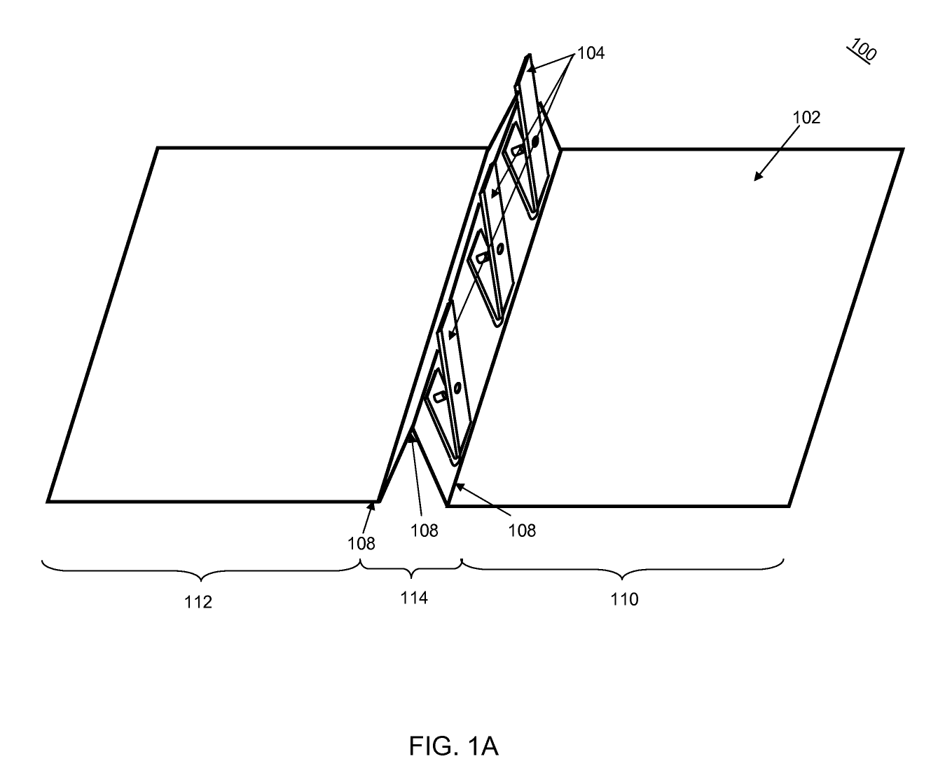

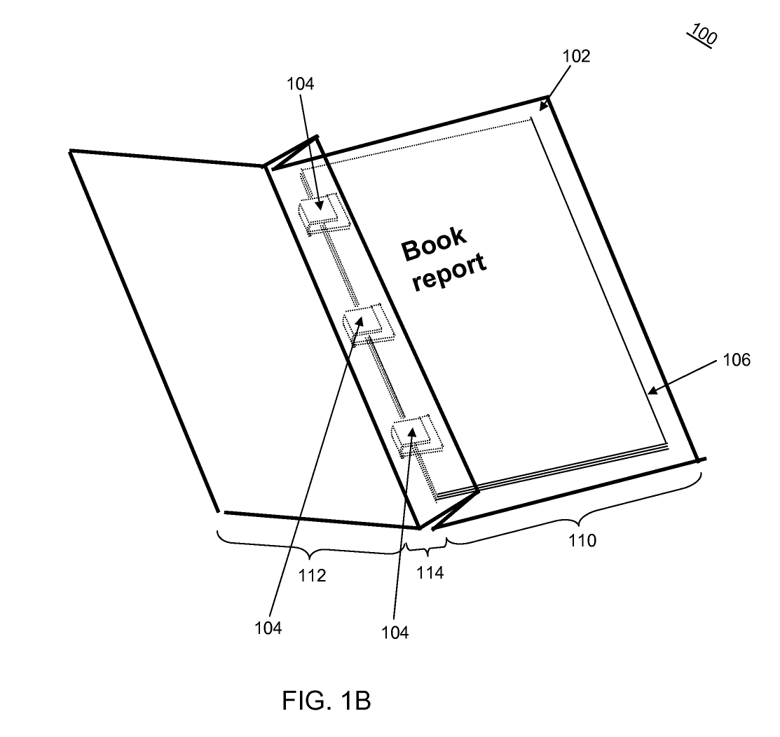

Referring to FIGS. 1A-1B, in exemplary embodiments, a folder with enhanced paper binding fixtures 100 can include a folder 102 and at least one paper binding fixture 104. Further, folder 102 can include a plurality of hinges 108. Hinges 108 can be produced by any reasonable technique such as, but not limited to, pre-folding folder 102, scoring folder 102, and/or by any reasonable technique to encourage folder 102 to bend in a desired direction.

In exemplary embodiments, hinges 108 can be located in folder 102 such that folder 102 has a substantially three-dimensional shape. For example, folder 102, can be segmented into a first region 110, a second region 112, and a third region 114.

In some instances, first region 110 and second region 112 can be substantially planar while third region 114 can include a three-dimensional pattern created by a plurality of hinges 108. As shown in FIG. 1A, with respect to first region 110 and second region 112 lying substantially flat, third region 114 can include at least two surfaces which extend substantially at an angle (e.g., about 10 to 170 degrees, perpendicular, about 45 degrees, etc.) from first region 110 and second region 112. As shown in FIG. 1B, first region 110 and second region 112 can be at an angle to each other and third region 114, located between first region 110 and second region 112, can attach the two regions to form a “W” shape (e.g., a “W” shaped cross-section).

Referring to FIG. 1B, in exemplary embodiments, paper binding fixture 104 can be designed to retain a plurality of sheets of paper 106. Further, based on the shape of folder 102, paper binding fixture 104 can be located behind at least a portion of third region 114. That is, when papers are bound by paper binding fixture 104 within folder 102, paper binding fixture 104 may not be substantially visible.

In exemplary embodiments, folder 102 can be constructed of a polymeric material, such as, but not limited to, plastic; a paper material, such as, but not limited to a single pulp and/or a plurality of pulps; and/or a combination of a paper material and a polymer such as, but not limited to, a pulp material with a protective coating, to name a few. It will be understood that folder 102 can be constructed of any reasonable material capable of being affixed to paper binding fixture 104 and/or folded into a three-dimensional shape. Folder 102 can be any reasonable color and can be substantially impervious to light, translucent, and/or opaque.

In some instances, paper binding fixture 104 can be at least one of semi-permanently affixed, releasably affixed, and/or permanently affixed to folder 102. Paper binding fixture 104 can be affixed to folder 102 by, for example, heat welding, adhesive, ultra-sonic welding, and riveting, to name a few. It will be understood that any reasonable adhesive can be used to affix paper binding fixture 104 to folder 102 such as, but not limited to, urea-formaldehyde, resorcinol, phenol formaldehyde resin, animal glues, polyvinyl acetate, polyurethane glue, epoxy, cyanoacrylate, contact cement, hot melt, hot bitumen, and cold adhesives.

In exemplary embodiments, paper binding fixture 104 can be semi-permanently affixed and permanently affixed to folder 102 to, for example, reduce the risk of a child, and/or any other user and/or animal, swallowing paper binding fixture 104.

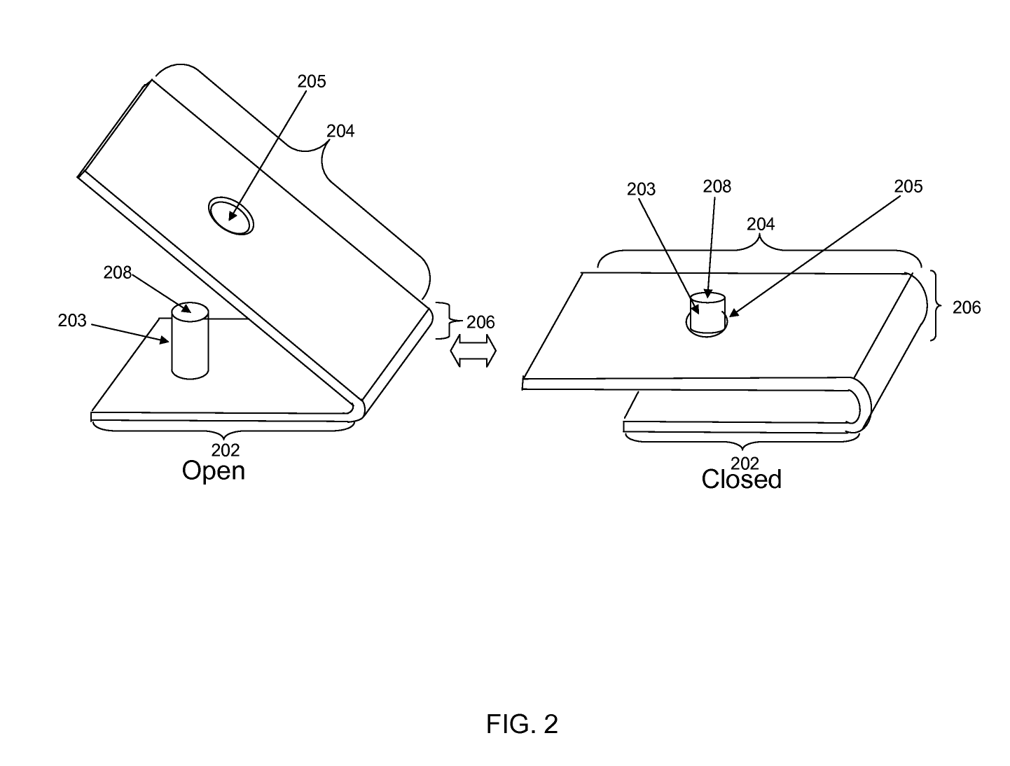

Referring to FIG. 2, in some instances, paper binding fixture 104 can include a male protrusion region 202, a male protrusion 203, a female receiving region 204, a female opening 205, and a bending region 206 configured such that paper binding fixture can be opened and closed at least once. In some instances, male protrusion 203 and female opening 205 can releasably couple by friction fit, mechanical interaction, plastic deformation, elastic deformation, and/or by any other reasonable technique for coupling male protrusion 203 and female protrusion 205.

In exemplary embodiments, each of male protrusion region 202, male protrusion 203, female receiving region 204, female opening 205, and bending region 206 can be produced from substantially the same material. For example, paper binding fixture 104 can be produced from a polymeric material such as, but not limited to, a plastic. In some instances, any of male protrusion region 202, male protrusion 203, female receiving region 204, female opening 205, and bending region 206 can be produced from substantially different materials. For example, male protrusion 203 can be produced from a more rigid plastic than the remaining portion of paper binding fixture 104.

In exemplary embodiments, paper binding fixture 104, can be designed to bend open and closed such that bending region 206 can deform. For example, bending region 206 can substantially elastically deform and/or can deform a combination of elastically and plastically. Further, for example, bending region 206 can plastically deform a plurality of times. That is, paper binding fixture 104 can be designed to be reused such that paper binding fixture 104 can open and close a plurality of times.

In exemplary embodiments, bending region 206 can flex (e.g., deform) a plurality of times between an opened and a closed position. For example, after a plurality of uses bending region 206 may fail. For example, bending region 206 can fail such that a crack is produced. Further, in some instances, female opening 205 and male protrusion 203 can be designed to fail affixing before bending region 206 fails. For example, female opening 205 and male protrusion 203 can fail such that they no longer releasably couple before bending region 206 fails creating a crack. The failure to no longer releasably couple can be caused by, for example, a failure such that male protrusion 203 and female opening 205 no longer couple by, for example, frictional and/or mechanical interactions. This may be done to ensure that paper binding fixture 104 is not a substantial risk to a child who may swallow a portion of paper binding fixture 104 that has failed at binding portion 206 causing paper binding fixture to break into two parts. That is, the system can be designed to fail such that it is replaced prior to a failure which could present a safety hazard to a child.

It will be understood that any male protrusion region 202, male protrusion 203, female receiving region 204, female opening 205, and bending region 206 can be flex (e.g., deform) when opening and closing paper binding fixture 104. For ease, at times, only bending region 206 is illustrated as flexing, deforming, bending, etc. This is merely for ease and is in no way intended to be a limitation. Further, any description of flexing, bending, deforming, etc. can be interchanged for the remaining elements of paper binding fixture 104.

It will be understood that any of male protrusion region 202, male protrusion 203, female receiving region 204, female opening 205, and bending region 206 can be combined and/or further separated without deviating from the scope of the disclosure. For ease, at times, each of male protrusion region 202, male protrusion 203, female receiving region 204, female opening 205, and bending region 206 are described as separate regions and/or elements. This is merely for ease and is in no way intended to be a limitation.

Further, although illustrated as a substantially solid material, bending region 206 can include regions without material and/or additional material. For example, a plurality of holes, slits, and/or surface variations may be located at bending region 206 such that bending region 206 can open and close a plurality of times.

In exemplary embodiments, male protrusion 203 can include a substantially monolithic material extending from male protrusion region 202. For example, male protrusion 203 can be a substantially solid plastic material. In some instances female opening 205 can be created by removing a region of material from female receiving region 204.

In exemplary embodiments, male protrusion 203 and/or female opening 205 can include a plurality of materials. For example, male protrusion 203 can include a first material that can substantially support male protrusion 203 and a second material added to the surface of male protrusion 203. For example, female opening 205 can be created by removing a region of material from female receiving region 204 and adding a second material to the interior surface/edge of female opening 205. This second material on either female opening 205 and/or male protrusion 203 can include a material that is designed to deform, maintain rigidity, and/or any other material that is capable releasably coupling male protrusion 203 within female opening 205. For example, this second material can be a polymer such as a rubber coating, a lower density plastic, and/or any other reasonable material.

In exemplary embodiments, male protrusion 203 can be any reasonable shape, such as, but not limit to a, round columnar shape, square columnar shape, oval columnar shape, hexagonal columnar shape, star columnar shape, triangular columnar shape, rectangular columnar shape, rectangular cuboid, square cuboid, trapezohedron, and/or any other reasonable shape for being placed at least partially within female opening 205. For ease, male protrusion 203 is depicted, at times, as round columnar, this is in no way meant to be a limitation.

In exemplary embodiments, the cross-section of female opening 205 can be any reasonable shape, such as, but not limit to round, square, oval, hexagonal, star, triangular, rectangular, trapezoidal, and/or any other reasonable shape for receiving male protrusion 203. For ease, female opening 205 is depicted, at times, as round, this is in no way meant to be a limitation.

In exemplary embodiments, the cross-sectional shape and/or surface of male protrusion 203 can substantially reduce the stress concentration, for example, on sheets of paper (not shown) bound on it. For example, male protrusion 203 can be substantially round and/or rounded to reduce the amount of stress distributed to paper located on it when, for example, a lateral force is applied to the paper. By way of example, if a hole punch in a paper (not shown) is round and male protrusion has a substantially round cross-section than the stress concentration on the paper would be lower than if, for example, male protrusion 203 had a substantially sharp edge. That is, the shape of a hole in a sheet of paper located on male protrusion 203 and the shape of male protrusion 203 can be selected to reduce stress concentration that could, for example, decrease the chances of tearing the paper.

Further, in exemplary embodiments, male protrusion 203 can be shaped to substantially reduce the risk of injuries to a user by, for example, reducing sharp surfaces and/or edges. For example, injuries can be reduced because the sidewall of male protrusion 203 can be substantially rounded and/or may not include sharp edges. As another example, top surface 208 of male protrusion 203 can include a surface area that is large enough to substantially distribute force placed on it rather than substantially concentrate force placed on it. Further, top surface 208, can be shaped to substantially reduce the risk of injury to a user. For example, top surface 208 can be rounded.

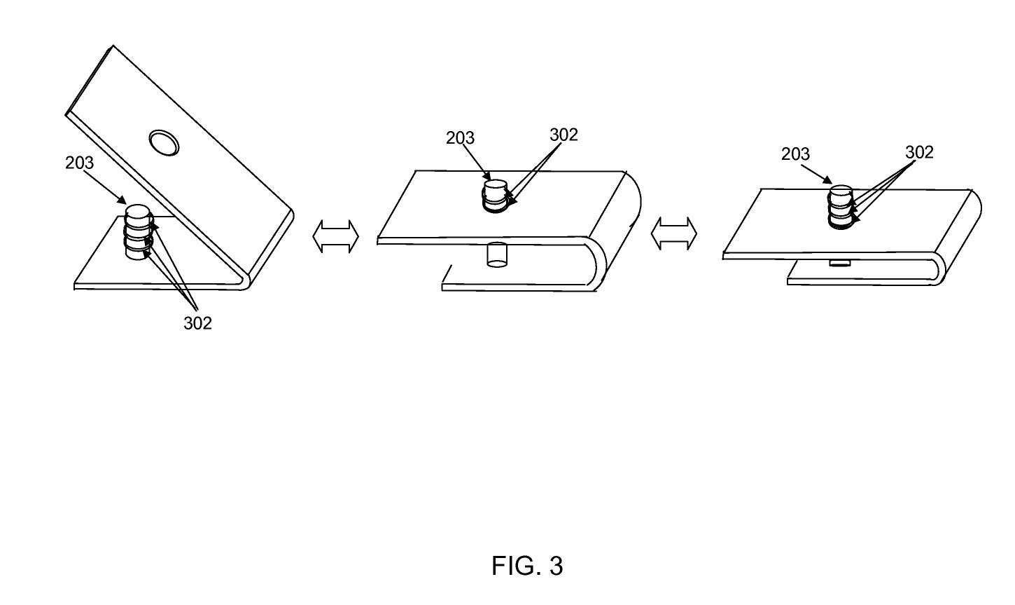

Referring to FIG. 3, in exemplary embodiments, male protrusion 203 can include geometric variations 302 on its outer surface such as, but not limited to, a thread pattern, ribbed pattern, bumped pattern, dimpled pattern, swirl pattern, and/or any other reasonable geometric variation. These geometric variations 302 can allow fastener 104 to close at varying heights. For example, if only a few sheets of paper are located on male protrusion 203 then fastener 104 can close to a shorter height than if many sheets of paper are located on male protrusion 203.

Referring to FIG. 4, at least one of male protrusion 203 and female opening 205 can be designed to punch a hole through at least one sheet of paper. For example, top surface 402 of male protrusion 203 can include a substantially shaped top surface 402 that can be designed to pierce through a sheet of paper. The shape of top surface 402 can be designed to pierce through a sheet of paper without substantially increasing the danger to a user. For example, the shape can be rounded such that a thin sheet of paper can be pierced while the flesh of a user would not be injured by applying a similar amount of force. Further, female opening 205 can include a sharp edge (not shown) for encouraging cutting a hole in a sheet of paper. This sharp edge can be located within female opening 205 and/or on the surface of female opening 205.

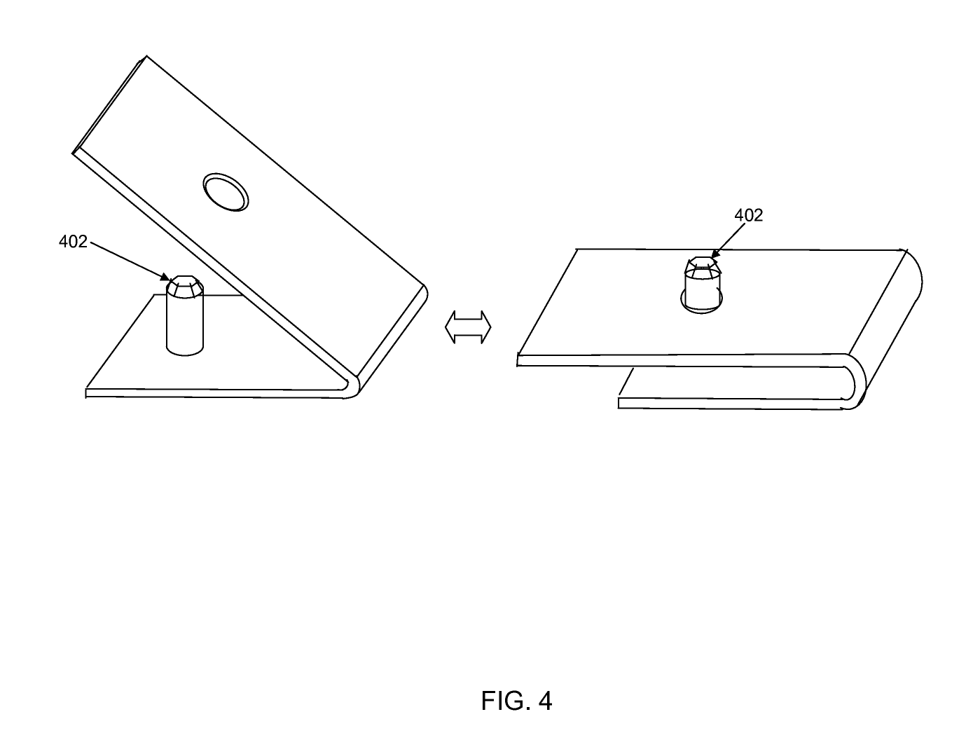

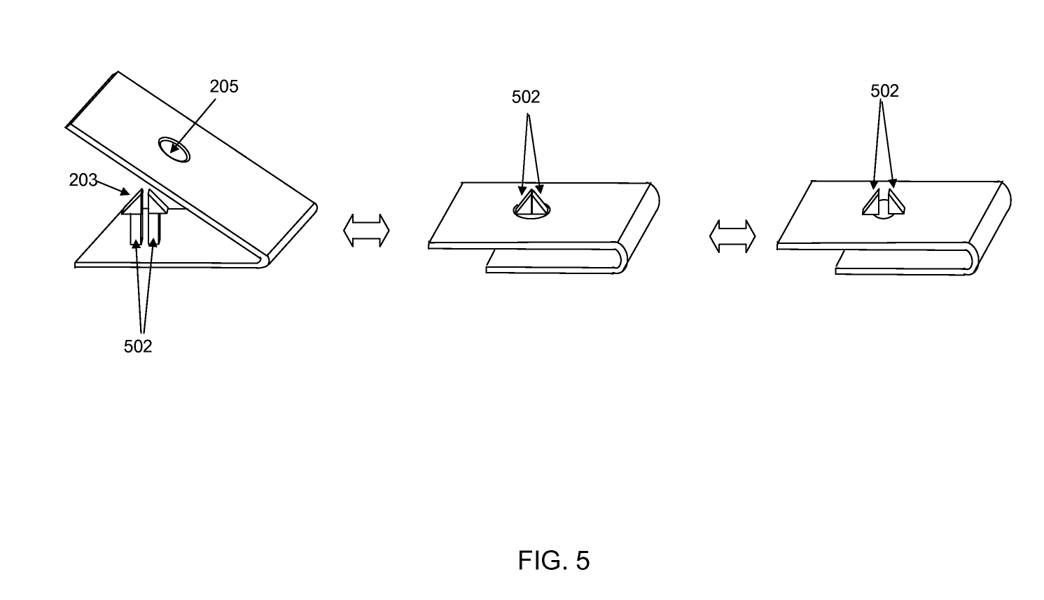

Referring to FIG. 5, in exemplary embodiments, male protrusion 203 can be constructed of a plurality of components 502 designed to move relative to one another. For example, components 502 can be designed such that they can be elastically flexed together and received through opening 205 and then released such that they return to their unflexed condition thereby temporarily locking fixture 104.

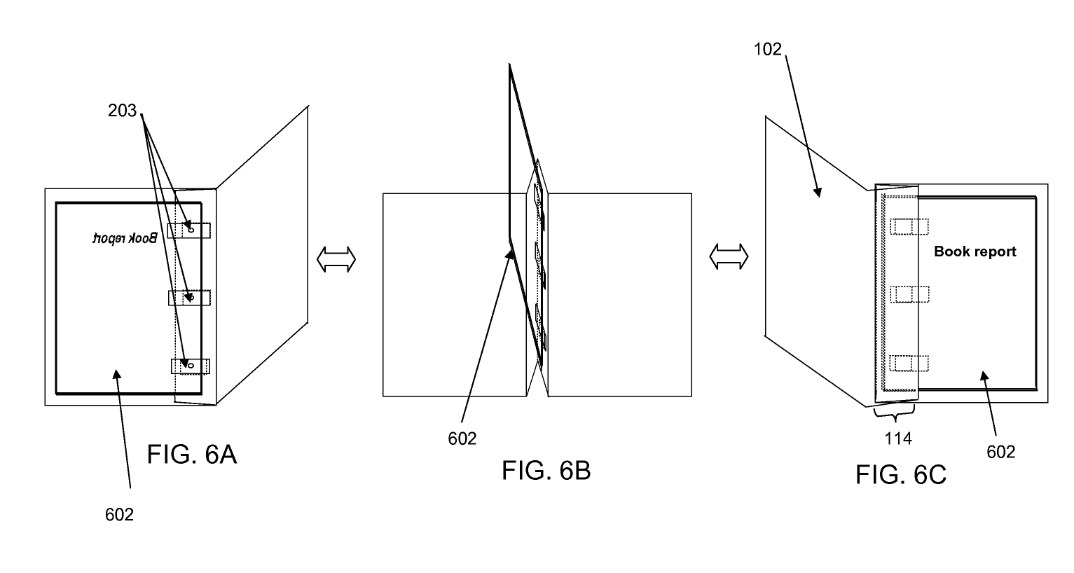

Referring to FIG. 6A, sheet of papers 602 can be placed facing down on male protrusions 203 and as the sheets of paper can be flipped over, as shown in FIG. 6A, and finally placed into a viewing position, as shown in FIG. 6C. In this position, sheets of paper 602 are completely flipped over and male protrusion 205 faces away from a reader. Further, as shown in FIG. 6C, paper binding fixture 104 can be substantially covered by third section 114 of folder 102.

In some instances, male protrusion 203 can have a defined height to bind a plurality of sheets of paper. For example, a longer male protrusion 203 can hold a larger quantity of sheets of paper than a shorter male protrusion 203. In some instance, male protrusion 203 can adjust in height by, for example, adding extensions and/or telescoping, to name a few.

In exemplary embodiments, male protrusion 203 and female opening 205 can be located on different surfaces. For example, male protrusion 203 is illustrated as facing up when paper is placed on it, however, it can be located facing down when paper is placed on it. For ease, male protrusion 203 is illustrated as facing up when paper is placed on it. This is in no way meant to be a limitation.

In exemplary embodiments, any of the elements of the folder with enhanced paper binding fixtures can be constructed of recycled materials and/or recyclable materials such that some and/or all of the elements of the folder with enhanced paper binding fixtures can be recycled and/or made of recycled materials. For example, any and/or all of the elements of the folder with enhanced paper binding fixtures can be fabricated from recyclable materials such as, but not limited to, plastics, polyethylene, ultra high molecular weight polyethylene (UHMWPE), ultra low molecular weight polyethylene (ULMWPE or PE-WAX), high molecular weight polyethylene (HMWPE), high density polyethylene (HDPE), high density cross-linked polyethylene (HDXLPE), cross-linked polyethylene (PEX or XLPE), medium density polyethylene (MDPE), linear low density polyethylene (LLDPE), low density polyethylene (LDPE), very low density polyethylene (VLDPE), any combination or separation thereof, and/or any other recycled and/or recyclable materials.

In exemplary embodiments, fastener 104 can include a plurality of male protrusions 203 and/or female openings 205. For ease, fastener 104 is illustrated as including only one male protrusion 203 and one female opening 205 per fastener. This is in no way meant to be a limitation.

Now that exemplary embodiments of the present invention have been shown and described in detail, various modifications and improvements thereon will become readily apparent to those skilled in the art.

What is claimed is:

1. A folder having at least one binding fixture, comprising:
a folder;
an at least one binding fixture coupled to the folder, the at least one binding fixture comprising an at least one male protrusion and an at least one female opening;
the at least one male protrusion being constructed such that paper with holes in it are capable of being placed on the at least one male protrusion; and
wherein the at least one male protrusion is received by and releasably coupled to the at least one female opening such that paper is releasably retained by the at least one binding fixture coupled to the folder.

2. The folder of claim 1, wherein the at least one binding fixture is designed to substantially reduce the risk of injuring a user and damaging the retained paper.

3. The folder of claim 1, wherein the folder is further comprising:
at least one hinge that enables the folder to at least one of bend and have a three-dimensional shape.

4. The folder of claim 1, wherein the folder is further comprising:
a plurality of hinges segmenting the folder into a first region, a second region, and a third region;
the first region and second region being substantially planer in shape; and
the third region being located between the first and second region and extending at an angle to at least one of the first region and the second region.

5. The folder of claim 4, wherein the third region is further comprising a plurality of surfaces forming a “W” shape with the first and second region.

6. The folder of claim 1, wherein the at least one binding fixture is at least one of releasably coupled to the folder, permanently affixed to the folder, and semi-permanently affixed to the folder.

7. The folder of claim 1, wherein the at least one binding fixture is at least one of semi-permanently affixed to the folder and permanently affixed to the folder to reduce the risk injury due to swallowing the at least one binding fixture.

8. The folder of claim 1, wherein the at least one male protrusion is releasably coupled to the at least one female opening by at least one of (i) a frictional interaction of at least one of the male protrusion and female opening, (ii) plastic deformation of at least one of the male protrusion and female opening, and (iii) elastic deformation of at least one of the male protrusion and female opening.

9. The folder of claim 1, wherein the at least one binding fixture is further comprising:
an at least one male protrusion region wherein the at least one male protrusion is located;
an at least one female receiving region wherein the at least one female opening is located; and
a bending region located between the at least one male protrusion region and female receiving region, wherein the bending region deforms when the at least one male protrusion is received by and releasably coupled to the at least one female opening.

10. The folder of claim 9, wherein at least one of:
(i) the male protrusion and female opening are designed to fail such that the binding fixture no longer retains paper;
(ii) the bending region is designed to fail such that the binding fixture no longer retains paper; and
wherein the failure such that the binding fixture no longer retains paper is designed to reduce the risk injury due to swallowing pieces of the at least one binding fixture.

11. The folder of claim 1, wherein the male protrusion is constructed such that it does not include sharp surfaces and edges; and
wherein the male protrusion does not include sharp surfaces and edges to at least one of (i) reduce the risk of injury to a user and (ii) reduce the stress concentration on paper retained by the binding fixture.

12. The folder of claim 1, wherein at least one of the male protrusion is further comprising geometric variations on its surface and female opening is further comprising geometric variations on its surface n.

13. The folder of claim 12, wherein the geometric variations interact such that male protrusion and female opening releasably couple.

14. The folder of claim 12, wherein the geometric variations interact such that the male protrusion and female opening can releasably couple at various offsets.

15. The folder of claim 1, wherein the folder and the at least one binding fixture are fabricated from at least one of a recyclable material and recycled material to provide the benefit of reducing waste.

16. The folder of claim 15, where the material is at least one of a plastics, polyethylene, ultra high molecular weight polyethylene (UHMWPE), ultra low molecular weight polyethylene (ULMWPE or PE-WAX), high molecular weight polyethylene (HMWPE), high density polyethylene (HDPE), high density cross-linked polyethylene (HDXLPE), cross-linked polyethylene (PEX or XLPE), medium density polyethylene (MDPE), linear low density polyethylene (LLDPE), low density polyethylene (LDPE), and very low density polyethylene (VLDPE).
